(19) United States
(12) Patent Application Publication
(10) Pub. No.: US 2005/0254056 A1
(43) Pub. Date: Nov. 17, 2005

(54) System and method for controlling the light source of a cavity ringdown spectrometer

(76) Inventors: Alexander Kachanov, Sunnyvale, CA (US); Barbara Paldus, Portola Valley, CA (US); Serguei Koulikov, Los Altos, CA (US)

Correspondence Address: Herbert Burkard, 480 Oakmead Parkway, Sunnyvale, CA, 94085, US

(21) Appl. No.: 10/845,338

(22) Filed: May 13, 2004

(51) Int. Cl. G01N 21/61

(52) U.S. Cl. 356/437

(57) ABSTRACT

A system and method for controlling the light source of a cavity ring-down spectrometer (CRDS). The system comprises a resonant optical cavity having at least two high reflectivity mirrors; a source for providing a continuous wave optical signal into the optical cavity, the source comprising an electrically pumped semiconductor gain medium; and a SOA interposed between the optical signal source and the optical cavity. The SOA receives the optical signal and transmits it to the resonant optical cavity. The system also includes a first detector for monitoring the intensity of radiation emitted from said cavity and generating a first detection signal based thereon; and at least a first controller for deactivating the optical signal based on a comparison of the first detection signal and a predetermined threshold and for thereafter reactivating the optical signal after a delay period in excess of the ring-down time of the optical cavity, the deactivating and reactivating being achieved by respectively turning off and then turning on electrical current to the SOA.

### FIELD OF THE INVENTION

This invention relates to cavity ring-down absorption spectroscopy (CRDS). In particular, this invention relates to an apparatus and method for controlling the input of laser light into the resonant optical cavity of a CRDS instrument.

### BACKGROUND OF THE INVENTION

Cavity Ring-Down Spectroscopy (CRDS) is an increasingly widely used technique for detecting and monitoring analytes, especially when the target analyte is present in very low concentration. Techniques are available which enable the use of CRDS with gaseous, liquid or solid samples. Various aspects of CRDS are described in numerous U.S. Pat. Nos. such as 5,815,277, 5,903,358, 5,912,740, 6,084,682, 6,094,267, 6,233,052, 6,377,350, 6,452,680, 6,466,322 and 6,532,071. Cavity Ringdown Spectroscopy by K. W Busch and M. A Busch, ACS Symposium Series No 720, 1999 ISBN 0-8412-3600-3, gives a comprehensive, and generally up to date, overview of many aspects of CRDS technology.

In essence, CRDS involves measuring the decay time (ringdown time) of a high finesse optical cavity (the ring-down cavity). The cavity is formed from at least two and preferably three or four ultra-high reflectivity dielectric mirrors, which comprise the optical resonator. Monochromatic light from a laser is injected into the cavity which encloses the analyte sample. Cavity ring-down spectroscopy involves measuring the absorption of radiation by a sample (analyte) via the effects of this absorption on the decay rate (referred to as the “ring-down decay constant” τ) of an optical cavity. The absorption is measured as a function of the wavelength of light resonating in the cavity to obtain the desired spectrum and/or concentration of a target analyte.

The decay rate (time) is determined by:
i) the round trip path length of the optical beam within the cavity;
ii) losses inherent in the cavity itself (primarily diffraction losses and transmission losses through the cavity mirrors); and
iii) most importantly, since it provides the basis for the analysis, losses due to the frequency dependent absorption by the target analyte.

Since factors i) and ii) are independent of the analyte, the analyte spectrum is determined by the frequency dependent decay time of the resonant cavity with the target analyte present after loss ii) is subtracted.

A major advantage of CRDS relative to conventional absorption spectroscopy is that it does not depend on a power-ratio measurement but rather provides an absolute measurement (i.e, decay time).

The optical cavity is initially filled with radiation from a laser, and ring-downs are measured by interrupting this incoming radiation. The light present within the cavity then decays with a characteristic exponential waveform. The laser output power and cavity finesse are two factors that determine the maximum intracavity power that can be achieved. It is important for the purpose of high-resolution spectroscopy that the wavelength of the laser be precisely known at the time each ring-down occurs. The accuracy to which the ring-down time constant of the exponential waveform can be measured improves with increasing intra-cavity optical intensity, so it is desirable to make this quantity (the “cavity filling”) as large as possible. After the cavity is filled and ringdown is to be initiated, it is also desirable that the incoming radiation to the cavity be shut off as completely and rapidly as possible. Otherwise, the decay waveform becomes a convolution of the laser turn-off characteristic and the cavity response, leading to a non-exponential decay.

Several factors limit how much cavity filling can be achieved in practice. Due to the very high finesse (very narrow line width) of the cavity, small fluctuations in the laser wavelength (or the cavity length) can cause the incident light to go into and out of resonance with the cavity. When this happens, the intra-cavity intensity may decrease or fluctuate irregularly while the laser remains turned on. In addition, filling uniformity also affects the repetition rate and hence measurement speed. It is therefore doubly important for the laser to have minimal frequency jitter. For a semiconductor laser, the wavelength is a very sensitive function of both the pump current to, and the temperature of, the laser, making the control of these quantities very important. In particular, achieving good cavity filling at each of a collection of wavelengths (as required for a spectral scan) needs a very low-noise current source and the ability to control the laser pump current over a moderately wide bandwidth to maintain the laser output at the desired wavelength set point while the cavity fills up.

A Cavity ring-down spectrometer comprises the following components:
i) the resonant optical cavity which comprises at least two, and preferably three or four, high reflectivity mirrors;
ii) an electrically pumped, semiconductor laser which may, for example, be an external-cavity diode laser (ECDL) or a distributed feedback (DFB) diode laser. The laser provides the light (radiation) which is emitted into the resonant cavity. The wavelength of the radiation produced by the laser gain medium is dependent on both the temperature of the gain medium and the current pumped into it. For purposes of spectroscopy it is necessary to provide means to tune, i.e., alter the wavelength of the light emitted by the gain medium into the optical cavity to be close to a wavelength absorbed by a target analyte species or to scan over a specific absorption feature. DFB and ECDL lasers are, in general, relatively narrowly tunable(<10 nm). Alternatively, a DBR (Distributed Bragg Reflector) laser can be utilized. DBR laser are particularly advantageous where broad tunability (>10 nm) is required. Likewise, an array of DFB or DBR lasers on a single chip, with the lasers of the array having contiguous tuning ranges, can be utilized to provide a broadly tunable system. In such a case the system which controls the laser emission wavelength will first select from the array a particular DFB having a desired emission wavelength.
iii) means for turning off (deactivating) the optical signal into the resonant cavity when the laser is at the desired wavelength and the optical cavity contains photons in a quantity above a threshold level. The threshold is basically determined by the inherent signal to noise ratio of the particular CRDS instrument, since the higher the ratio, the higher the threshold, i.e., the number of photons in the cavity required to obtain good spectroscopic results. “Turning off” the light into the cavity results in a “ring-down” (exponential decay). After the cavity has “rung-down”, light from the laser is again directed into the optical cavity to fill it up to the threshold level, the incoming optical signal is again turned off (deactivated) and the ring-down process repeated. The distinctive spectrum for any given analyte results from performing the ring-down process over a more or less broad range of wavelengths.

A preferred embodiment of the present invention includes the following additional components:
a) a second detector for monitoring the wavelength of the reactivated optical signal and generating a second detection signal based thereon;
b) a second controller coupled to said second detector which second controller adjusts both the temperature of, and the current to, said gain medium to thereby achieve a desired emission wavelength;
c) means for adjusting the beam path length of the optical cavity such as a piezoelectric transducer capable of translating one of the cavity mirrors to bring the cavity into resonance with said desired emission wavelength.

There are a number of conventionally used methods for deactivating the optical signal into the resonant optical cavity in order to permit the cavity to ring-down:
i) change the beam path so that it is no longer aimed at the cavity input mirror;
ii) frequency shift the laser emission out of the resonance range of the cavity. This can be achieved by varying the input current to the gain medium;
iii) turn off the current from the current source to the laser, or as a variation, shunt the current to an alternative medium, preferably one having electrical properties (e.g., resistance, capacitance and/or inductance) similar to that of the laser gain medium.

Normally, in methods i) and ii) the laser remains on at all times. The first method conventionally utilizes an acousto-optic modulator (AOM), as hereinafter described. In method iii) the current flow to the laser gain medium is turned off (terminated) thereby temporarily deactivating the source of the optical signal. Approaches for directly modulating the laser current to turn off the radiation have been proposed to reduce the cost of CRDS instrumentation. However, this approach must allow the laser emission wavelength to stabilize each time the current into the gain medium is turned back on, which, of necessity, limits the repetition rate of the system.

A conventional two-mirror, continuous wave (CW) CRDS instrument (200) using an AOM to deactivate the optical signal by changing the beam path (method i) is shown in FIG. 1.

As shown in FIG. 1, light is generated from a narrow band, tunable, continuous wave diode laser 202. Laser 202 is temperature tuned by a temperature controller (not shown) to emit its radiation at a wavelength approximately equal to a desired spectral line of the analyte. An acousto-optic modulator (AOM) 204 is positioned in front of the radiation emitted from laser 202. AOM 204 provides a means for providing light 206 from laser 202 along the optical axis 219 of resonant cavity 218. Light 206 exits AOM 204 and is directed by mirrors 208 and 210 to cavity mirror 220 as light 206a which travels along optical axis 219 and exponentially decays between cavity mirrors 220 and 222 when light 206 is deflected from the cavity axis. The measure of this decay is indicative of the presence or lack thereof of a trace species. Detector 212 is coupled between the output of optical cavity 218 and controller 214. Controller 214 is coupled to laser 202, processor 216, and AOM 204. Processor 216 processes signals from optical detector 212 in order to determine the level of trace species in optical resonator 218.

In AOM 204, a transducer (not shown) creates a sound wave that modulates the index of refraction in an active nonlinear crystal (not shown), through a photoelastic effect. The sound wave produces a Bragg diffraction grating that disperses incoming light into multiple orders, predominantly zero order and first order. Different orders have different light beam energy and follow different beam directions. In CW-CRDS, typically, a first order light beam 206 is aligned along with optical axis 219 of cavity 218 incident on the cavity in-coupling mirror 220, and a zero order beam 224 is idled with a different optical path (higher order beams are very weak and thus not addressed). Thus, AOM 204 controls the direction of beams 206 and 224.

When AOM 204 is on, most light power (typically, up to 80%, depending on size of the beam, crystals used in AOM 204, alignment, etc.) goes to the first order along optical axis 219 as light 206. The remaining beam power goes to the zero order (light 224), or higher orders. The first order beam 206 is used for the input coupling light source; the zero order beam 224 can be used for diagnostic components. Once sufficient light energy is built up within the cavity. AOM 204 is turned off. This results in all the beam power going to the zero order as light 224, and no light 206 is coupled into resonant cavity 218. In order to “turn off” the laser light to optical cavity 218, and thus allow for energy within optical cavity 218 to ring down, AOM 204, under the control of controller 214, redirects (deflects) light from laser 204 along path 224 and thus away from optical path 206 into optical resonator 218. The light energy inside the cavity then follows an exponential decay (i.e., “rings down”).

A point to be noted is that in this system the laser itself is always turned on, which is frequently advantageous. However, use of an AOM creates a number of problems. Such systems are rather complex and expensive since, among other things, RF power to the AOM is required and the diffraction angle is wavelength dependent.

One approach which utilizes method iii) is described in published U.S. patent application 2003/0210398 and provides an alternative to using an AOM to turn off the transmission of photons into the optical cavity. The system described in Application U.S. 2003/0210398 is reported to function as follows:
i) a controller does not redirect the laser light but actually deactivates (shuts off) the laser when the light emitted from the cavity reaches a predetermined threshold. The laser is turned off by shutting off the current to the laser;
ii) the laser remains turned off for a fixed period, significantly exceeding the ring-down time, and the cavity rings-down during the initial portion of the fixed shut-off period;
iii) the light source is turned back on at the end of this first shut-off period to thereby initiate a second fixed period during which the restarted laser “stabilizes”. By setting the laser temperature to an appropriate value, by the end of this period the laser emission frequency is allegedly stabilized at a value which is approximately correct for a given target analyte. The current to the laser is then modulated to more finely vary the laser emission frequency until it coincides with a cavity resonance mode at some point during the modulation, thereby resulting in energy build-up within the fixed length cavity.

While this system may sometimes have advantages over a system using an AOM to turn off the light into the optical cavity it is not capable of achieving the degree of precision achievable with an optimized CRDS instrument because of the need to repeatedly turn the laser on and off, thereby resulting in a low repetition rate.

### BRIEF DESCRIPTION OF THE INVENTION

The present invention is directed to a CRDS instrument and method which activates (turns on) and shuts off (deactivates) the light into the resonant optical cavity using a SOA (semi-conductor optical amplifier) in lieu of prior art methods i) through iii), above. Note that an alternative terminology sometimes used for SOA is BOA (booster optical amplifier) or VOA (variable optical amplifier which describes a particular type of SOA). There are two main types of SOAs, the Fabry-Perot SOA and the traveling-wave SOA. Although either type is suitable for the practice of the present invention, we have found the traveling wave SOA to be generally preferable.

Unlike method iii) as described above, but like methods i ) and ii), above, in the present invention the laser itself is always on. However, the method and apparatus of the present invention differs significantly and very advantageously from any of the prior art methods and apparatus. The laser frequency is not changed out of resonance as in method ii) nor is the beam position changed as in method i).

The method of the present invention includes the following steps:
i) directing a continuous wave optical signal, preferably from an optically pumped semi-conductor diode laser, into a resonant optical cavity comprising at least two, and preferably three or four, high reflectivity mirrors;
ii) using a first detector to monitor the radiation emitted from the optical cavity through one of these mirrors (the output mirror), and determine when the intensity of the emitted radiation is equal to a pre-determined threshold value. Suitable detectors include, for example, photodiodes, avalanche photodiodes and photo-multiplier tubes. The power of the radiation impinging on the detector is equal to the power of the radiation circulating in the resonant cavity multiplied by the power transmission coefficient of the output mirror. The threshold must be sufficient to provide an adequate signal to noise ratio and thereby provide an accurate determination of the ring-down decay constant τ.
iii) shutting off, or reverse biasing the current to a SOA located in the optical train between the laser and the optical cavity to block or at least substantially attenuate the optical signal into the laser cavity to thereby permit the cavity to ring-down.
iv) as soon as ringdown is complete, resume current flow to, or forward bias, the SOA to thereby amplify the optical signal and cause it to again be directed into the optical cavity to refill it.

Note that in the practice of the present invention the laser is always on and preferably its emission wavelength is being continuously monitored by a controller to provide active feedback which enables precise control of the laser emission wavelength. A SOA can be switched on/off very rapidly (e.g., in 100 ns), which affords a data acquisition rate (DAQ) of 10 KHz. This is highly advantageous since it means that the DAQ is limited by the decay constant of the cavity rather than by laser switching dynamics. Also, unlike an AOM design the SOA of our invention can function over a broad wavelength band(40-120 nm). Additionally, a SOA can be co-packaged with the laser source which results in a compact, wavelength-stable light source for CRDS.

When a DFB or other semiconductor laser is maintained at constant temperature and the pump current is first raised from zero to a constant value, the wavelength of the laser changes rapidly (over up to a few tenths of a nm) before approaching its steady-state value on a timescale of a few milliseconds. We have found that by using a feedback circuit to vary the laser current, while simultaneously monitoring the laser output wavelength, it becomes possible to significantly reduce undesirable variation in the laser output wavelength, which is important for accurate spectroscopic analysis. Moreover, if the laser wavelength is stable, a more regular buildup of light inside the cavity is achieved, leading in turn to a more regular DAQ.

A Semiconductor Optical Amplifier (SOA) is an optical device which has been used for some years primarily in the telecommunications industry, especially in wavelength-division-multiplexed (WDM) networks. An extensive discussion of SOA technology is found in “Semiconductor Optical Amplifiers” by M. J. Connelly, Kluwer Academic Publishers, January 2002, ISBN 0-7923-7657-9. See also, for example, the Gallop and Conforti article. IEEE Photonics Technology letters Vol. 14. No. 7, July 2002 pp 902-904; U.S. Pat. No. 6,714,345; and Laser Focus World, April, 1997 Vol. 33, Issue #4, and the references cited in any of the previously cited references. The disclosures of these and any other references cited herein are incorporated herein by this reference.

Optical amplification by a SOA relies on the known physical mechanisms of population inversion and stimulated emission. More specifically, amplification of an optical signal depends on the stimulated transmission of an optical medium from an inverted, excited state to a lower, less excited state. Prior to the actual amplification of the optical signal, a population inversion occurs, i.e., more upper excited states exist than lower states. This population inversion is effected by appropriately energizing the system. In SOAs an excited state is a state in which there exists an electron in the conduction band and a concomitant hole in the valence band. A transition from such an excited state, to a lower state in which neither an electron nor a hole exists, results in the creation of a photon or a stimulated emission. The population inversion is depleted every time an optical signal passes through the amplifier and is amplified. The population inversion is then reestablished over some finite period of time. As a result, the gain of the amplifier will be reduced for some given period of time following the passage of any optical signal through the amplifier. This recovery of time, is typically denoted as the “gain-recovery time” of the amplifier. In contrast to rare earth-doped amplifiers, semiconductor optical amplifiers are smaller, consume less power and can be more easily formed in an array. Although a wide variety of known SOAs are suitable in the practice of the present invention, preferred SOAs are based on single chips of materials such as InP, InGaAsP, AlGaAs and InAlGaAs configured as a ridge waveguide. Although so-called “bulk” SOAs are also suitable, particularly preferred SOAs for use in the present invention are strained layer multi quantum well (MQW) SOAs as described in “Physics of Optoelectronic Devices” by S. L. Chuang, Wiley Interscience (1995), and P. J. A. Thijs et. al., IEEE J. Quantum Electron, pp 477-499 (1994). Other suitable SOAs are described for example in published U.S. application 2004/057,485. A VOA is a particular type of SOA, where the input voltage is reverse biased and can be varied to control the amount of attenuation. VOAs are primarily used to equalize the output power of a tunable laser over a broad tuning range. The term SOA as used herein and in the appended claims is intended to encompass BOAs and VOAs.

The use of a SOA to turn off the light into the optical cavity in lieu of, for example, an AOM or direct modulation of the current to the laser gain medium has a number of important advantages including those set forth below:
1) For the same optical power into the cavity, since the SOA is by definition an amplifier (by an order of magnitude or more), a lower power (and hence cheaper and/or more readily available) laser can be used.
2) The most efficient AOM performance as an on/off switch is approximately 60 dB. We have found that SOA attenuation provides a much higher extinction ratio (in excess of 70 dB) over its entire gain bandwidth, which, in turn, permits more precise measurement of τ. This limitation is inherent in AOM modulation since even after the ringdown trigger signal is sent to the AOM, light will continue to be transmitted into the optical cavity for the period of time required for the signal from the transducer on the AOM to pass through the AOM medium to intersect the light beam.
3) Since the laser can always remain on, wavelength stability and data acquisition rates are superior in comparison with those prior art methods where the laser is repeatedly turned off and on.
4) In many instrument configurations it is advantageous to have one or more optic fiber segments to transmit light from the gain medium to the optical cavity. Coupling to and from such fiber optic segments attenuates transmitted power, but the amplification provided by the SOA is normally sufficient to overcome the effect of any power loss.
5) Many available SOAs function over a broad wavelength band and so can efficiently be used in a CRDS analytical instrument which uses a broadband tunable laser to scan an analyte over a broad wavelength range. For example, SOAs based on the material GaₓIn₁₋ₓAs_{y}P_{y-1} can provide gain within the range of 1000 nm to 1650 nm, depending on the relative concentration of the constituent elements. GaₓIn₁₋ₓAs_{y}P_{y-1} can provide gain within the range of 1000 nm to 1650 nm again depending on the relative concentration of the constituent elements.
6) Since a SOA intrinsically functions as a waveguide it is free from the wavelength dependent diffraction angle effect which occurs with an AOM.
7) An AOM optical switch requires RF power for operation. In contrast, a SOA requires only conventional variable current which is not radio frequency, which in turn permits much simpler system electronics.
8) Many lasers cannot be directly modulated, e.g., external cavity diode lasers. Likewise, directly modulating an array of DFB lasers is prone to wavelength error due to cross-talk which will adversely affect the instrument performance, including data acquisition speed. A SOA is free from this problem.
9) For many spectroscopic analyses lasers having an emission wavelength above 1600 nm are required. Such lasers are generally of relatively low power, typically below 10 mW. Unless enhanced by a SOA, a poor signal/noise ratio in the instrument is frequently present.
10) If it is desired to utilize an array of lasers, it is entirely feasible to utilize a corresponding array of SOAs.
11) A SOA will not have a tendency to alter the emission frequency of the laser.
12) For broadly tunable lasers, such as external cavity diode lasers, the SOA allows a tradeoff between broad tunability and low laser power, by providing amplification. For example, this allows the use of 80 to 120 nm relatively low power, tunable lasers in CRDS while still achieving good performance.

### BRIEF DESCRIPTION OF THE DRAWING

FIG. 1 is a diagrammatic representation of a CRDS instrument in accordance with the prior art.

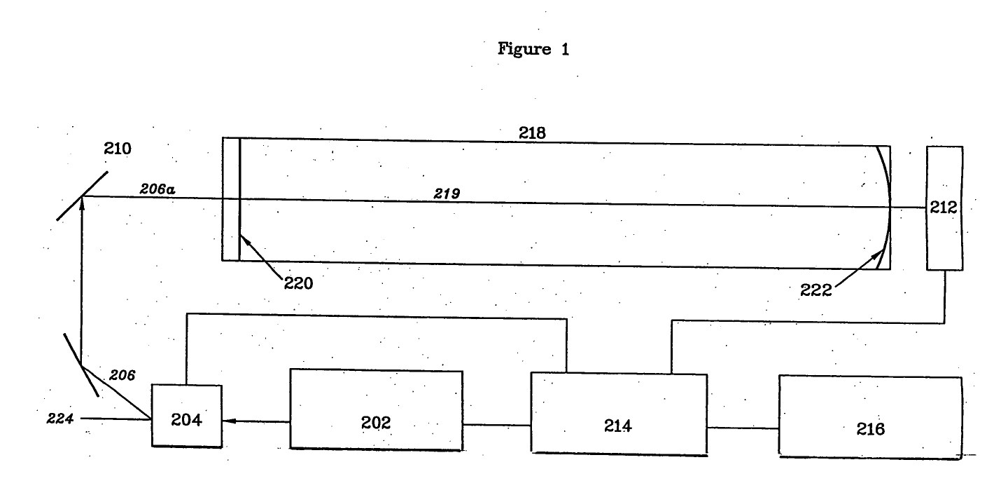

FIGS. 2a-2d show various SOA design configurations all of which are useable in the practice of the current invention.

FIG. 3 is a diagrammatic representation of a CRDS instrument in accordance with the present invention using a SOA to control the input of laser light into the optical cavity.

FIG. 4 illustrates the use of multiples lasers 1-4 which feed into a single SOA and thence into an optical cavity. The light amplification power of a SOA enables the use of plural laser sources of low power as shown in this FIG. 4.

FIG. 5 shows an alternative design utilizing a multiple array of lasers 1-4 feeding into a single SOA and thence into the optical cavity.

FIG. 6 shows a single SOA, single laser design where the SOA can be reverse biased.

FIG. 7. illustrates a design for co-packaging the laser and SOA (7A) and a design where the laser gain medium and SOA are integrated on a single chip (7B).

### DETAILED DESCRIPTION OF THE DRAWINGS

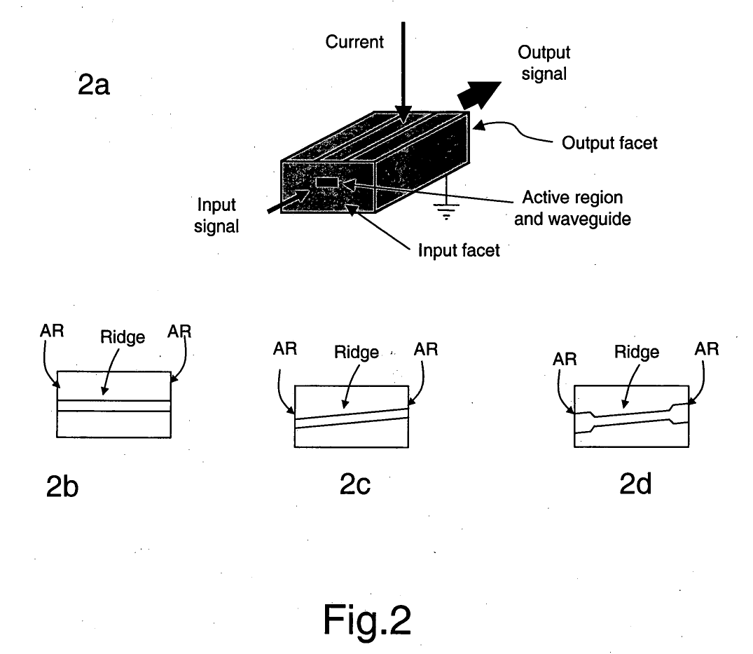

FIG. 2a is schematic diagram of a SOA having a straight, uniform cross-section waveguide. Note that, as shown, all types of SOA's normally will have an anti-refection coating on both facet faces.

FIG. 2b is a top view of a SOA having a straight, uniform cross-section waveguide as in the SOA shown in 2a.

FIG. 2c is a top view of an angled-facet waveguide SOA. The active region is slanted away from the facet cleavage plane thereby reducing the effective facet reflectivity. Relative reflectivity also decreases as the wave-guide width increases. However, excess width can result in the appearance of higher order transverse modes. This can be overcome by broadening the wave guide near the end facets as shown in FIG. 2d which presents a top view of an angled facet, flared waveguide SOA.

Alterative SOA configurations (not shown) which have been found suitable in the practice of the current invention include buried ridge wave guide SOA's and strained quantum well wave guide SOAs.

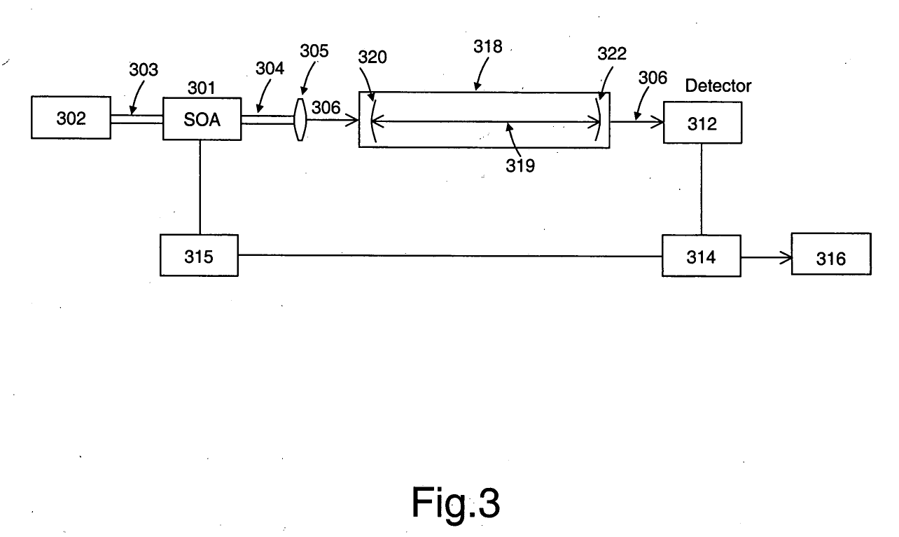

One embodiment of our invention is shown in FIG. 3. The beam from laser 302 passes via optical fiber 303 into SOA 301 and thence via optic fiber 304 into mode matching lens 305 and thence as beam 306 into resonant optical cavity 318, having two high reflectivity mirrors 320 and 322 which define cavity optical axis 319. When cavity 318 has filled to at least the threshold level as measured by detector 312, which is coupled between the output of cavity 318 and controller 314. Controller 314 is also coupled to data analysis system 316 and unit 315 which interacts with SOA 301 to cause it to interrupt the passage of light from laser 302 to cavity 318. The preferred method is to shunt the current flow from SOA 301 to ground. However, alternative methods which are sometimes appropriate, involve simply shutting off the current flow to the SOA or reverse biasing it. Normally shutting off the current flow to the SOA will cause complete or at the least sufficient attenuation of the light into the optical cavity to cause it to ring down. However, in some cases such as where the wavelength of the light is very close to the band gap of the SOA medium then the extinction ratio may be insufficient unless the direction of the current flow to the SOA is reversed (i.e. the SOA is reverse biased). As soon as SOA 301 stops light beam 306, the measurements of the ring down will commence. After a time interval sufficient to ensure ringdown detection, controller will instruct unit 315 to again cause current to be directed to SOA 301 so as to again permit light to flow into and fill cavity 318 and again initiate the ringdown cycle.

A CRDS instrument having a three mirror optical cavity similar to that described in U.S. Pat. No. 5,912,740 and configured as shown in FIG. 3 was assembled using a Covega Model BOA-1004-15-3-0-1-PAA SOA This SOA is InP based and has the following characteristics: 80 nm optical bandwidth, 16 dB saturation output power, fiber to fiber gain 15 dB.

Using 1.4 Watts of input current (500 milliamps) commercial, external cavity DFB diode laser, we were able to achieve 45 mW of output power at 1550 nm and 38 mW at 1520 nm. The extinction ratio achieved was 68 dB at 1529 nm and 73 dB at 1550 nm. These results significantly exceed those achievable with all existing methods for turning off/on the light into a CRDS optical cavity.

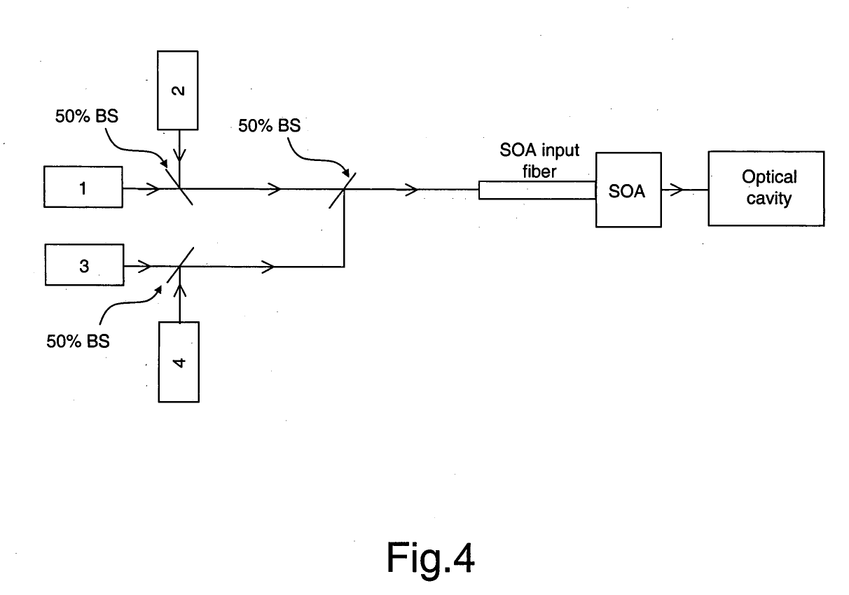

FIG. 4 illustrates one of the significant advantages resulting from the use of a SOA as the mechanism for interrupting light into the optical cavity. As can be seen, any one of lasers numbered 1 to 4 of different emission wavelengths can be selected, one at a time, to provide light into the optical cavity. Three 50/50 beam splitters (marked BS) are provided which are 50% transmitting mirrors and which enable complete control over the incoming light wavelength since they are wavelength independent, broad band splitters. The passage of the light from the lasers to the beam splitters can be either via optical fiber, as shown, or through free space depending on the design considerations applicable to the particular CRDS instrument. Absent the light amplification power of a SOA, the loss caused by the use of the 50% beam splitters, plus, if utilized, optical fiber coupling would normally result in insufficient light into the resonant cavity. Thus the use of the SOA significantly expands the available laser light source options.

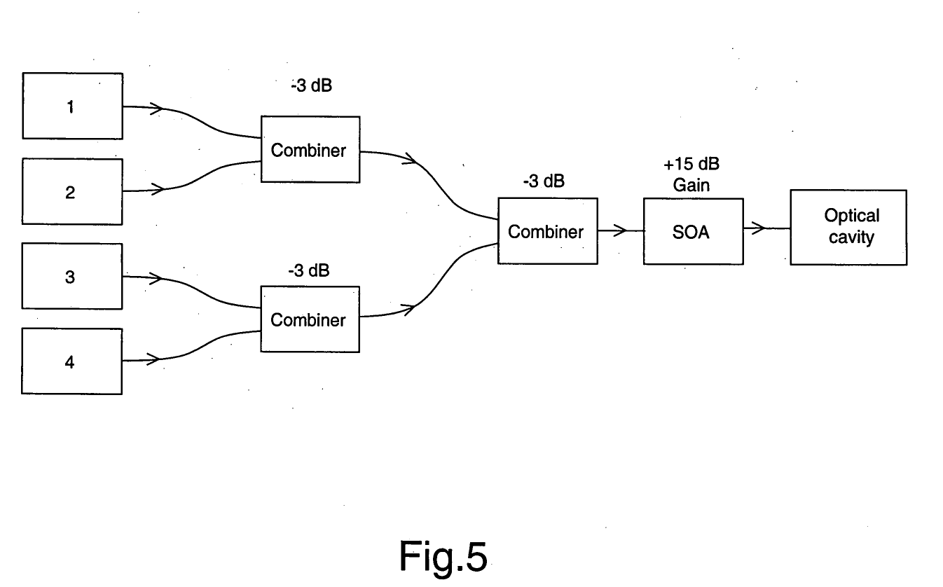

FIG. 5 is an alternative design, which uses optical fiber converters (sometimes called Y splitters) in conjunction with lasers again numbered 1 to 4. As indicated, each fiber optic combiner will have approximately 3 dB of loss. However, since the SOA can provide e.g., 15 dB of gain, there is sufficient power into the optical cavity.

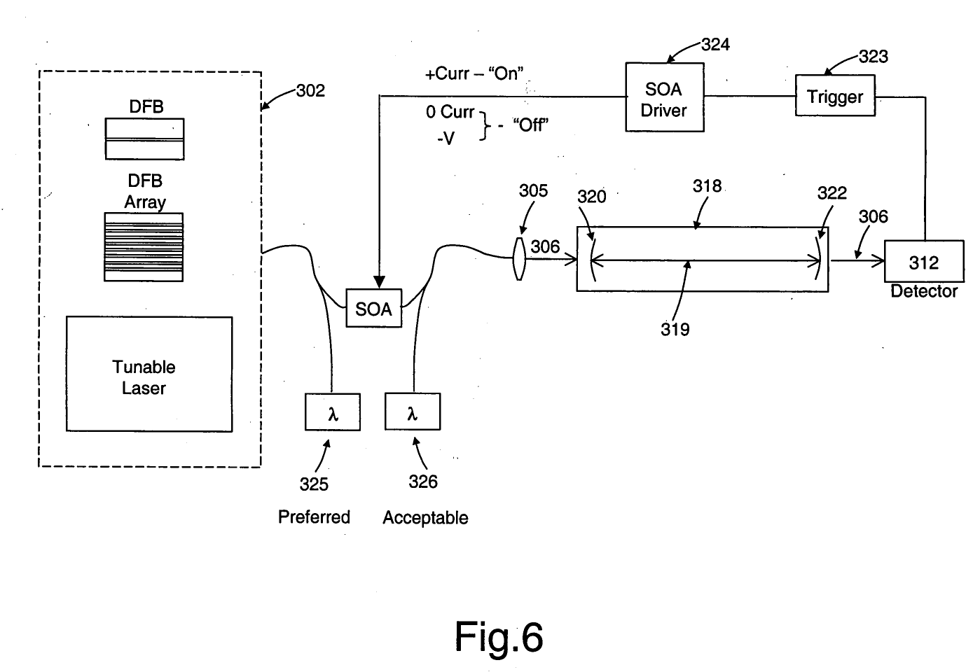

FIG. 6 illustrates a variation of the apparatus illustrated in FIG. 3. Number 302 indicates the laser source. As shown, suitable sources include a tunable laser, e.g., a DFB or DBR laser or a DFB or DBR laser array. Number 318 again denotes the resonant optical cavity. Number 323 and 324 denotes, respectively the trigger which, in response to detector 312, instructs SOA driver 324 to turn the current to SOA. 301 on or off or, if desired, to reverse bias the current, in which event the SOA will actually absorb any light coming into it from laser 302. The passage of the light from laser 302 through SOA 301 and thence through focusing lens 305 into optical cavity 318 can be through free space, via optic fiber or a combination thereof. Units 325 and 326 denote alternative locations for a wavelength monitor which, as shown at 325, is preferably located between the laser 302 and SOA 301. However, in many circumstances it is acceptable to locate the wavelength monitor between the SOA and the optical cavity as shown at 326. Not shown is a second controller coupled to either wavelength monitor 325 or 326 which can adjust both the temperature of, and the current to, laser 302 to finely adjust the emission wavelength. A suitable monitor comprises an etalon, a beam splitter and a pair of photodiodes. A second controller will normally be coupled to said monitor and will include means for substantially continuously monitoring the temperature of the gain medium, and look-up tables indicating the temperature and current required to cause a desired laser emission wavelength.

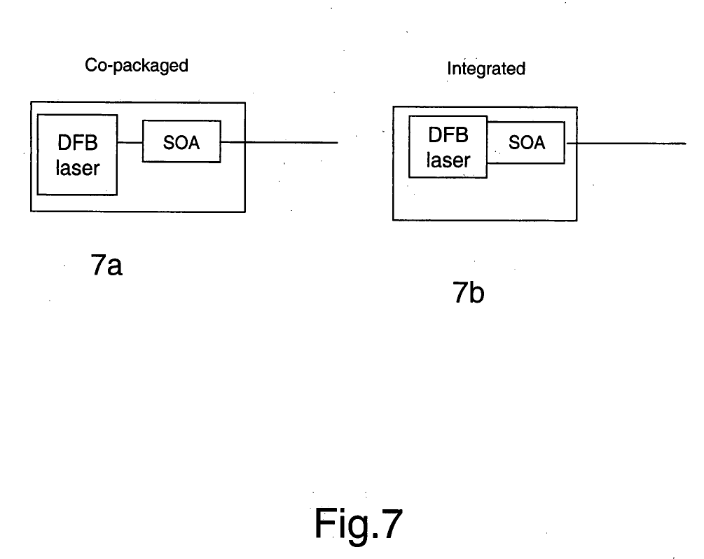

FIG. 7 shows that the laser (e.g., a DBF laser is shown, although other lasers such as a DBR or ECDL are also suitable) and the SOA can be co-packaged or integrated on a single chip. Both designs have advantages. The integrated approach provides maximum compactness and avoids any loss in transmission. The advantages of the co-packaged design is that fabrication yields of the two components when made separately are generally higher and some wavelengths may not be readily available, or only very costly in an integrated design. It-is also feasible to create a broadly tunable laser system by combining a series of co-packaged or integrated lasers-SOAs with each laser having a different wavelength and providing control means to select any given laser—SOA combination for emission.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general.

Further, while the present invention has been particularly described in terms of certain preferred embodiments, the invention is not limited to such preferred embodiments. Rather, the scope of the invention is defined by the appended claims.

1) A cavity ring-down spectrometer comprising:
i) a resonant optical cavity comprising at least two high reflectivity mirrors;
ii) a source for providing a continuous wave optical signal into said optical cavity, said source comprising an electrically pumped semiconductor gain medium;
iii) a SOA interposed between said optical signal source and said optical cavity said SOA receiving said optical signal from said optical signal source and transmitting it to said resonant optical cavity;
iv) a first detector for monitoring the intensity of radiation emitted from said cavity and generating a first detection signal based thereon;
iv) at least a first controller for deactivating said optical signal based on a comparison of said first detection signal and a predetermined threshold and for thereafter reactivating said optical signal after a delay period in excess of the ring-down time for said optical cavity, said deactivating and reactivating being achieved by respectively turning off and then turning on electrical current to said SOA.

2) A cavity ring-down spectrometer in accordance with claim 1 wherein said optical signal source comprises at least one Distributed Bragg Reflector (DBR) or a Distributed Feedback Diode (DFB) laser.

3) A cavity ring-down spectrometer in accordance with claim 1 wherein said optical signal source comprises an array of fiber coupled lasers.

4) A cavity ring-down spectrometer in accordance with claim 1 wherein said optical signal source comprises an array of lasers integrated on a single chip.

5) A cavity ring-down spectrometer in accordance with claim 2 wherein said optical signal source is a broadly tunable DBR laser.

6) A cavity ring-down spectrometer in accordance with claim 2 wherein said optical signal source is a narrowly tunable DFB laser.

7) A cavity ring-down spectrometer in accordance with claim 1 wherein said optical signal source and said SOA are copackaged.

8) A cavity ring-down spectrometer in accordance with claim 1 wherein said laser and said SOA are integrated on a single chip.

9) A cavity ring-down spectrometer in accordance with claim 1 wherein said detector comprises a photodiode or avalanche photodiode.

10) A cavity ring-down spectrometer in accordance with claim 1 which comprises the following additional components:
v) a monitor for measuring the wavelength of the reactivated optical signal and generating a second detection signal based thereon;
vi) a second controller coupled to said monitor which second controller adjusts both the temperature of, and the current to, said gain medium to thereby achieve a desired emission wavelength;
vii) means for adjusting the beam path length of the optical cavity to bring it into resonance with said desired emission wavelength.

11) A cavity ring-down spectrometer in accordance with claim 10 wherein said current to said gain medium is terminated by shunting the current to an alternative medium.

12) A cavity ring-down spectrometer in accordance with claim 10 wherein said monitor comprises an etalon, a beam splitter and a pair of photodiodes.

13) A cavity ring-down spectrometer in accordance with claim 1 wherein said resonant optical cavity comprises three or four mirrors.

14) A cavity ring-down spectrometer in accordance with claim 10 wherein said second controller includes means for substantially continuously monitoring the temperature of the gain medium, and look-up tables indicating the temperature and current required to cause a desired laser emission wavelength.

15) A cavity ring-down spectrometer in accordance with claim 10, wherein said means for adjusting the beam path length of the optical cavity comprises a piezo-electric transducer capable of translating one of the cavity mirrors.

16) A cavity ring-down spectrometer in accordance with claim 1 wherein said optical signal source comprises a broadly tunable, external cavity diode laser.

17) A cavity ring-down spectrometer in accordance with claim 1 wherein said SOA is a Fabry-Perot or Traveling-wave SOA.

18) A cavity ring-down spectrometer in accordance with claim 1 wherein said SOA is a strained layer multi-quantum well SOA.

19) A method for detecting the presence of an analyte in a resonant optical cavity comprising at least two high reflectivity mirrors, said method comprising the steps of:
i) directing a continuous wave optical signal from an electrically pumped semiconductor gain medium through a SOA and thence into said optical cavity;
ii) detecting radiation emitted from said optical cavity through one of said mirrors and comparing the intensity of said emitted radiation with a predetermined threshold value;
iii) based on said comparison, generating a control signal which interrupts said optical signal into said optical cavity by terminating the flow of current to, or reverse biasing, said SOA for a period which is at least in excess of the ring-down time for said cavity;
iv) reactivating said current flow to said SOA to thereby again direct said optical signal into said optical cavity.

20) A method in accordance with claim 19 wherein said current flow is deactivated for a period of at least about three ring-down times.

21) A method in accordance with claim 19 comprising the additional steps of:
v) monitoring the wavelength of said optical signal;
vi) adjusting the temperature of, and current to, the source of said optical signal to thereby cause it to emit a signal having a desired wavelength;
vii) adjusting the beam path length of said optical cavity by translating at least one of said mirrors to thereby bring said cavity into resonance with said desired wavelength optical signal
